(19) United States
(12) Patent Application Publication
(10) Pub. No.: US 2009/0098286 A1
(43) Pub. Date: Apr. 16, 2009

(54) METHOD FOR FORMING BOND COATS FOR THERMAL BARRIER COATINGS ON TURBINE ENGINE COMPONENTS

(75) Inventors: Siu-Ching Lui, Green Brook, NJ (US); Chang-Jiu Li, Xi'an (CN); Guan-Jun Yang, Xi'an (CN)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/761,242

(22) Filed: Jun. 11, 2007

(51) Int. Cl. B05D 1/36; B05D 3/00; B24C 1/10

(52) U.S. Cl. 427/189; 427/201; 72/53

(57) ABSTRACT

A metal or alloy powder is cold sprayed onto a turbine engine component to form a bond coat. The bond coat is shot peened with particles at a sufficient velocity to compact and smooth the bond coat surface. The smooth surface promotes the formation of a stable and adhered alumina TGO layer. According to another embodiment, the bond coat is instead cold sprayed with particles at a velocity that is sufficient for the particles to compact and smooth the bond coat, and that is insufficient for the particles to bond with the bond coat. For both embodiments, a heat treatment process under controlled atmosphere may be necessary to promote bonding between bond coat and substrate and as a pre-oxidation step to form the TGO layer.

### FIELD OF THE INVENTION

The present invention generally relates to thermal barrier coatings for hot section metal components in gas turbine engines. More particularly, the present invention relates to bond coats for such thermal barrier coatings, and methods of forming such bond coats and preparing them to receive and secure thermal barrier coatings onto gas turbine engine components.

### BACKGROUND OF THE INVENTION

Turbine engines are used as the primary power source for various kinds of aircrafts. The engines are also auxiliary power sources that drive air compressors, hydraulic pumps, and industrial gas turbine (IGT) power generation. Further, the power from turbine engines is used for stationary power supplies such as backup electrical generators for hospitals and the like.

Most turbine engines generally follow the same basic power generation procedure. Compressed air is mixed with fuel and burned, and the expanding hot combustion gases are directed against stationary turbine vanes in the engine. The vanes turn the high velocity gas flow partially sideways to impinge on the turbine blades mounted on a rotatable turbine disk. The force of the impinging gas causes the turbine disk to spin at high speed. Jet propulsion engines use the power created by the rotating turbine disk to draw more air into the engine and the high velocity combustion gas is passed out of the gas turbine aft end to create forward thrust. Other engines use this power to turn one or more propellers, electrical generators, or other devices.

The hot section of a turbine engine that is exposed to the high velocity gas includes components that are built and/or coated using ceramic materials that are able to withstand high operational temperatures. Many components such as turbine blades are cast from metallic compounds or superalloys and are coated with thermal barrier coatings that insulate and protect the structures. Many ceramic thermal barrier coatings are capable of reducing the underlying component surface by 100 to 300° C. The durability of the coated metal component is therefore improved, which in turn enhances engine performance.

Secure bonding of ceramic thermal barrier coatings to a turbine engine component is commonly facilitated by an intermediate bond coating that is joined to both the component substrate and the thermal barrier coating. During the service life of the engine component an oxide scale may form at the interface of the ceramic and the bond coat as high temperatures cause the bond coat to oxidize. The oxide layer continues to grow in thickness during high temperature use. If the oxide layer becomes too thick, the overlying thermal barrier coating may spall. Oxide formation on the bond coat is unavoidable, so it is advantageous to take steps to control the manner and extent of the oxide growth in order to prevent the ceramic thermal barrier coating from spalling.

One way to control formation of an oxide scale is to form a stable film of thermally grown oxide (TGO) such as alumina that serves as a diffusion barrier to prevent further unwanted oxidation. Another conventional solution is to optimize the surface topology to promote strong anchoring of the thermal barrier coating onto the bond coat. Cold gas-dynamic spraying (hereinafter “cold spraying”) is a cost-effective process for forming a bond coat on a metal substrate. However, cold spraying tends to produce a bond coat that is typically dense at the base and becomes progressively less dense near the coating surface. Furthermore, cold spraying often produces a bond coat that includes less organized and more poorly integrated particles at the coating surface than throughout the bulk of the coating. Surface inconsistencies such as these tend to make the bond coat surface ill suited for anchoring the overlying ceramic material, and also are somewhat ineffective at forming a uniform and stable TGO. Some efforts to correct this problem have included mechanically removing the porous outer surface of the cold sprayed bond coating. However, this extra step takes time and also necessitates the removal of valuable bond coat material.

Accordingly, it is desirable to provide a cold sprayed bond coat that has a suitable outer surface for controlling a TGO formed thereon, and that provides an effective and long lasting anchor system for an overlying thermal barrier coating. In addition, it is desirable to provide efficient methods for forming such a bond coat that do not require waste of the cold sprayed bond coat material. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

According to one embodiment of the invention, a method is provided for forming a bond coat on a turbine engine component. First, a metal or alloy powder is cold sprayed onto the turbine engine component to form a bond coat. Then, the bond coat is shot peened with particles at a sufficient velocity to compact and smooth the bond coat.

According to another embodiment of the invention, another method is provided for forming a bond coat on a turbine engine component. First, a metal or alloy powder is cold sprayed onto the turbine engine component to form a bond coat. Then, the bond coat is cold sprayed with particles at a velocity that is sufficient for the particles to compact and smooth the bond coat, and that is insufficient for the particles to bond with the bond coat.

### BRIEF DESCRIPTION OF THE DRAWINGS

The present invention will hereinafter be described in conjunction with the following drawing figures, wherein like numerals denote like elements, and

FIG. 1 is a cross-sectional view depicting a turbine engine component substrate that is being cold sprayed with a bond coat material;

FIG. 2 is a cross-sectional view of the turbine engine component substrate depicted in FIG. 1 with a bond coat that is being compacted by pelting the bond coat with high velocity particles;

FIG. 3 is a cross-sectional view of the turbine engine component depicted in FIG. 2 after compacting the bond coat and after thermal treatment;

FIG. 4 is a cross-sectional view of the turbine engine component substrate depicted in FIG. 3 after forming a thermal barrier coating on the compacted bond coat;

FIG. 5 is a schematic view of an exemplary cold gas-dynamic spray apparatus;

FIG. 6 is a scanning electron micrograph of a cross-section of an as-formed bond coat cold sprayed on a substrate;

FIG. 7 is a scanning electron micrographs of the top of an as-formed bond coat cold sprayed on a substrate;

FIG. 8 is a scanning electron micrograph of a cross-section of an as-formed bond coat cold sprayed on a substrate, the sprayed powder being a ball-milled powder;

FIG. 9 is a scanning electron micrograph of the top of a bond coat cold sprayed on a substrate and shot peened using glass spheres, the sprayed powder being a ball-milled powder; and

FIG. 10 is a scanning electron micrograph of a cross-section of a bond coat cold sprayed on a substrate and shot peened using glass spheres with a TGO formed on the bond coat, the sprayed powder being a ball-milled powder.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides a compacted cold sprayed bond coat that has a suitable outer surface for effectively and permanently anchoring an overlying thermal barrier coating and managing growth of a TGO formed on the bond coat. The compacted bond coat is formable by different compaction methods. According to each method, the surface of a bond coat is bombarded with particles that do not bond, adhere, or otherwise become integrated with the bond coat. The particle materials, sizes, and velocities are selected to smooth and compact the bond coat surface and to thereby optimize the surface topology.

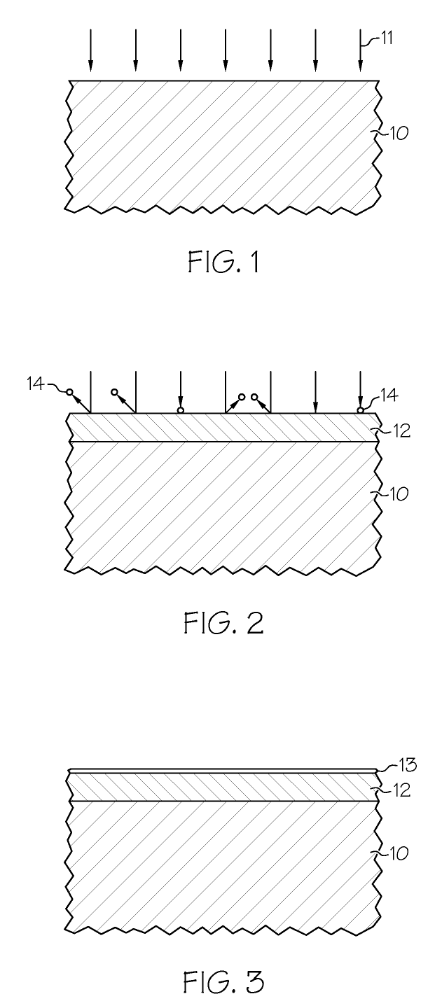

Turning now to FIG. 1, a cross-sectional view illustrates a turbine engine component substrate 10 that is being cold sprayed with a bond coat material represented by the arrows 11 directed to the substrate surface. The substrate 10 may be any turbine engine component that requires a thermal barrier coating. Such components are cast from metallic compounds or superalloys comprising durable metals that are highly susceptible to degradation without the protection provided by a thermal barrier coating, particularly when exposed to the highly corrosive environment of a gas turbine engine hot section. Just one class of substrate materials includes nickel based superalloys.

An exemplary bond coat material may be a feedstock powder of a pre-alloyed alloy such as MCrAlX wherein M is a metal such as Ni, Co, and combinations of Ni and Co, and X is a reactive element such as Y, Ta, Ti, Hf, and combinations thereof. According to an exemplary embodiment, the feedstock powder has an average particle size ranging between 5 and 100 microns. Furthermore, it may be advantageous to further mechanically work the powder to reduce the grain size to nanometer scale. Milling may be performed on the powder to reduce the particles to nano-scale grain size. According to one embodiment, the powder is ball milled under an inert environment for 36 to 48 hours, and the grain size of the ball-milled powder is reduced to nano-meter size ranging from 10 to 200 nm.

Cold spraying is a cost-effective process for forming the bond coat on the component substrate. Turning briefly to FIG. 5, an exemplary cold gas-dynamic spray system 100 is illustrated diagrammatically. The system 100 is illustrated as a general scheme, and additional features and components can be implemented into the system 100 as necessary. The main components of the cold-gas-dynamic spray system 100 include a powder feeder for providing powder materials, a carrier gas supply (typically including a gas heater) for heating and accelerating powder materials, a mixing chamber and a convergent-divergent nozzle. In general, the system 100 transports the powder mixtures with a suitable pressurized gas to the mixing chamber. The particles are accelerated by the pressurized carrier gas, such as air, helium, nitrogen, or mixtures thereof, through the specially designed nozzle and directed toward a targeted surface on the turbine component. When the particles strike the target surface, the kinetic energy of the particles is converted to heat and the particles are plastically deformed, which in turn causes the particles to bond with the target surface and to cohere with the solid splats previously and subsequently bonded to the target surface. Thus, the cold gas-dynamic spray system 100 can bond the powder materials to a turbine blade surface and thereby form a protective coating on the blade surface.

The cold gas dynamic spray process is referred to as a “cold spray” process because the particles are applied at a temperature that is well below their melting point. The kinetic energy of the particles on impact with the target surface, rather than particle temperature, causes the particles to plastically deform and bond with the target surface and to cohere with the solid splats previously and subsequently bonded to the target surface. Therefore, bonding to the blade surface, as well as deposition buildup, takes place as a solid state process with insufficient thermal energy to transition the solid powders to molten droplets.

A variety of different systems and implementations can be used to perform the cold gas-dynamic spraying process. For example, U.S. Pat. No. 5,302,414, entitled “Gas-Dynamic Spraying Method for Applying a Coating” describes an apparatus designed to accelerate materials and to mix particles of the materials with a process gas to provide the particles with a density of mass flow between 0.05 and 17 g/s·cm². Supersonic velocity is imparted to the gas flow, with the jet formed at high density and low temperature using a predetermined profile. The resulting gas and powder mixture is introduced into the supersonic jet to impart sufficient acceleration to ensure a particle velocity ranging between 300 and 1200 m/s. In this method, the particles are applied and deposited in the solid state, i.e., at a temperature which is considerably lower than the melting point of the powder material. The resulting coating is formed by deposition of particles of cold spray powders that are plastically deformed upon impacted and bonded to the surface.

According to the present invention, the cold gas-dynamic spray system 100 applies bond coat material onto the substrate 10. Although the process is referred to as “cold spraying,” some warming of the propellant gas and/or particles may be advantageous in order to provide the bond coat material with sufficient energy to bond with and/or embed into the substrate 10. However, any warming of the particles and/or the propellant gas is tailored to maintain the particle temperatures well below their melting points. As non limiting examples, the gases can comprise air, nitrogen, helium and mixtures thereof. Again, this system is but one example of the type of system that can be adapted to cold spray powder materials to the target surface. The cold gas-dynamic spray system 100 can deposit multiple layers of the same or different bond coat materials. The system 100 is typically operable in an ambient external environment.

After cold spraying the bond coat material 11 onto the substrate, a bond coat 12 is formed as depicted in FIG. 2. An exemplary bond coat 12 is formed at a thickness of 50 to 150 microns. As previously discussed, cold spraying tends to produce a bond coat that is dense at the base and becomes progressively less dense near the coating surface. Furthermore, cold spraying often produces a bond coat that includes less organized and more poorly integrated particles at the coating surface than throughout the bulk of the coating. Surface inconsistencies such as these tend to make the bond coat surface ill suited for anchoring the overlying ceramic material, and also are somewhat ineffective at forming a uniform and stable TGO.

To improve the bond coat surface without removing the outer portion, the surface roughness is reduced and the bond coat is compacted by pelting the bond coat surface with high velocity particles. FIG. 2 depicts the bond coat 12 being compacted by pelting the bond coat 12 with high velocity particles 14. The bond coat 12 is pelted with the high velocity particles 14 until the bond coat 12 has an optimal roughness that will anchor a subsequently formed thermal barrier coating and is also sufficiently smooth to promote the growth of a uniform and adherent TGO such as alumina upon oxidation of the bond coat 12 at high temperatures.

According to one exemplary embodiment, the bond coat is subjected to a shot impingement or peening process using fabricated spherical particles. Exemplary peening particles include glass spheres or spheres made from a metal such as stainless steel. FIG. 3 is a cross-sectional view of the turbine engine component depicted in FIG. 2 after compacting the bond coat 12 that is formed on the substrate 10. The bond coat 12 is smoother and more compact than before being subjected to the peening process. Also, a TGO 13 such as alumina is formed on the bond coat 12 after exposing the bond coat to controlled high temperatures.

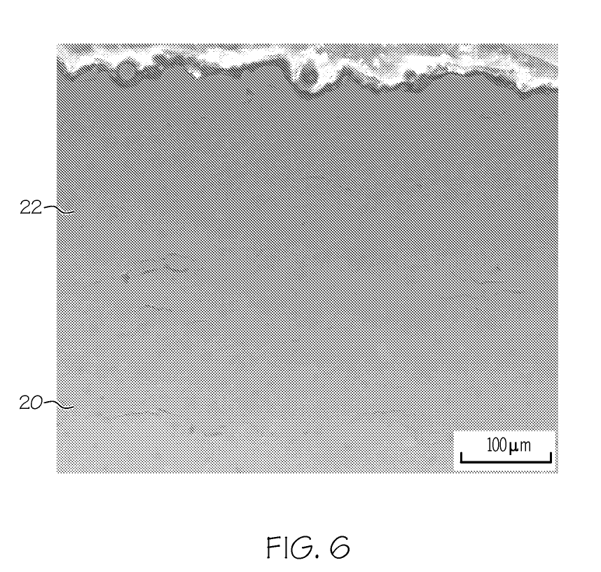

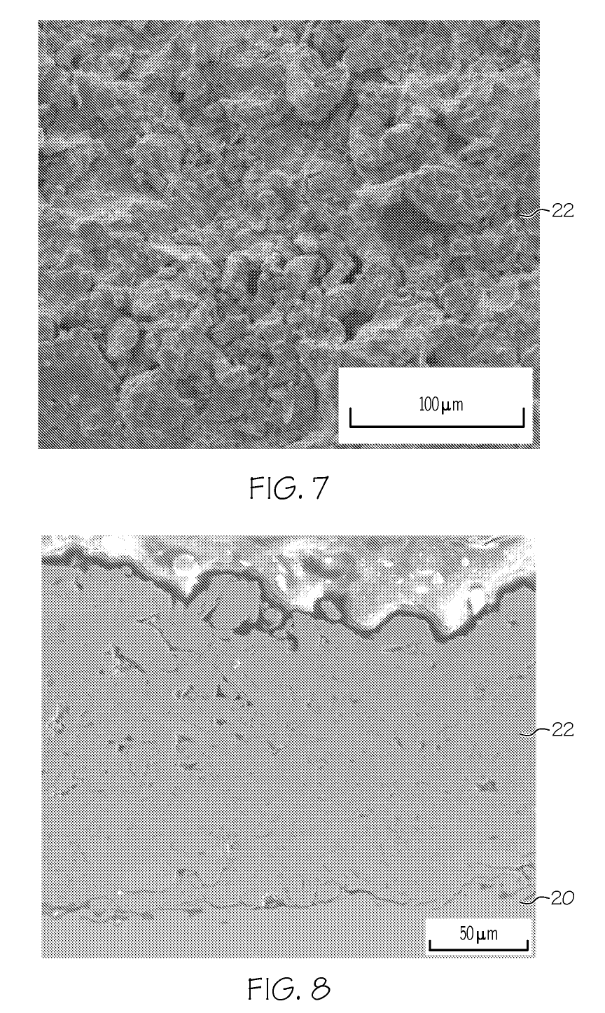

According to one exemplary embodiment, the bond coat was formed by cold spraying NiCrAlY powder using helium as an accelerating gas heated to 500° C. with a chamber pressure of 2.5 MPa. FIG. 6 is a scanning electron micrograph of a cross-section of an as-formed bond coat 22 on a substrate 20. The powder for deposition of the coating shown in FIG. 6 is a NiCrAlY alloy with a median particle size of about 50 microns. The powder can be mechanically worked to reduce the grain size to nanometer scale. According to an exemplary embodiment, milling is performed at a rotation speed of 180 rpm in a high-energy ball mill for 36 to 48 hours under an argon environment to reduce the grain size to nano-meter range. FIGS. 7 and 8 are scanning electron micrographs of the top and a cross-section of a bond coat 22 on a substrate 20 using the ball-milled, nano-structured powder. The grain size of the cold sprayed coating is similar to that of the spray powder, because the nano-structured characteristic of the powder is retained in the coating by the cold spray deposition at a low temperature. The grain size of the spray powder may be in the range of from 10 to 200 nm. The top view of FIG. 7 reveals a rough surface morphology for the bond coat 22. Many surface particles are not well integrated into the bulk of the bond coat 22. The cross-sectional view depicted in FIG. 8 further confirms that some surface particles are not integrated into the bond coat 22.

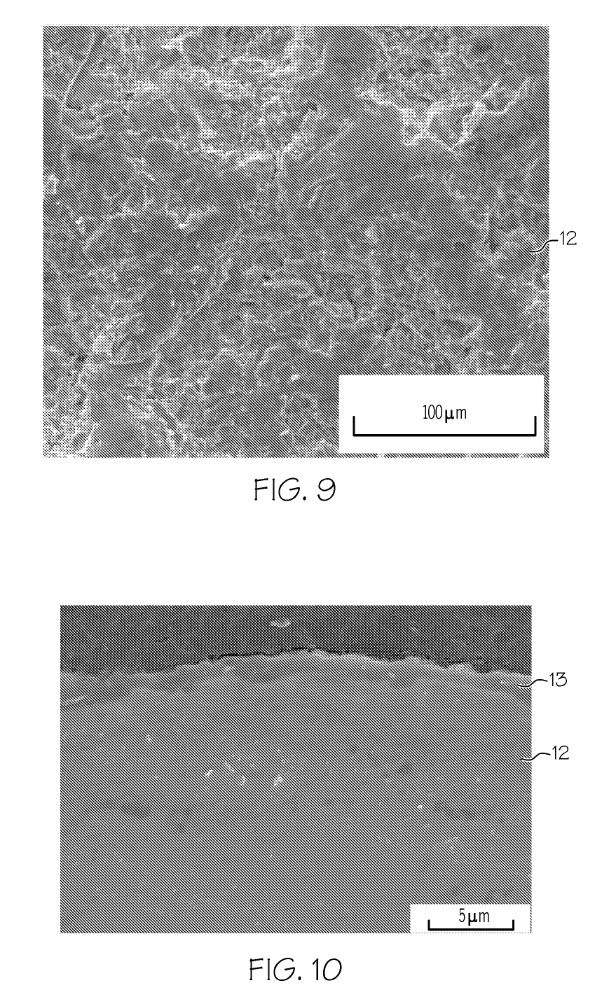

The surface roughness of bond coat was measured by performing profilometer traces along the surface to monitor the effect of shot peening. FIG. 9 is a scanning electron micrograph of the top of a bond coat 12 on the substrate 10 after shot peening the bond coat surface with glass spheres. The average surface roughness has been reduced from 5.26 microns at the as-formed state to 3.10 microns after completing the shot peening process. FIG. 9 reveals that shot peening produced a smoother bond coat outer surface.

To demonstrate the improvement provided by the shot peening process regarding formation of an alumina TGO 13 on the bond coat 12, oxidation of both the as-formed and shot peened coatings was conducted at 900° C. in the presence of air for different time periods. The micrograph of FIG. 10 reveals the improved surface morphology and uniformity of the alumina TGO 13 after oxidation at 900° C. for 50 hours after shot-peening the bond coat 12.

Returning to FIG. 2, according to another exemplary embodiment the cold spraying process that is performed to form the bond coat 12 is followed by a compacting process in which the particles 14 continue to be accelerated toward the bond coat 12 by the cold spraying apparatus that formed the bond coat 12. However, the particles 14 are sprayed at a reduced gas pressure and/or at a reduced gas temperature. Lowering the gas and/or powder temperature or reducing the gas pressure in the cold spraying apparatus reduces the particle energy. The lower particle energy causes the particles 14 to have a velocity upon impact with the bond coat 12 that is below a critical bonding velocity, and the particles 14 do not impact the bond coat 12 with sufficient energy to plastically deform and bond to the coat surface. However, the particles 14 do have sufficient energy to compact and smooth the bond coat 12 in the same manner as the spherical particles from the previously-disclosed embodiment. Further, the particles 14 improve the bond coat topology and compactness without eroding the bond coat surface.

An advantage provided by using cold sprayed particles 14 to compress and smooth the bond coat 12 is that both the bond coat formation and post-formation compacting processes are performed using the same cold spraying apparatus. Therefore, the overall process has improved efficiency when compared with the method involving a second, shot peening apparatus for performing the post-formation compacting process. Furthermore, the same material that is used to form the bond coat 12 may be used to perform the post-formation compacting process since the bond coat material is already loaded in the cold spraying powder feeder. Of course, different metals/alloy powders or other materials may also be loaded into the cold spraying powder feeder if it is desirable to perform the post-formation compacting process with a powder other than the bond coat material.

After the post-formation compacting process, a heat treatment may be performed to further promote bonding of the bond coat 12 to the substrate 10. The heat treatment is preferably formed in an inert atmosphere to avoid surface oxidation of the bond coat 12. The heat treatment may be performed at a temperature ranging between 900° C. to 1100° C. for a predetermined time period ranging between 1 to 20 hours. For example, according to one embodiment the coating 12 and substrate 10 are heat-treated at a temperature of 1000° C. for 4 hours in an argon atmosphere to promote bonding of bond coat 12 to substrate 10. However, the heat treatment can also be employed as a pre-oxidation process of the bond coat to form alumina TGO by adjusting the oxygen partial pressure in the inert gas atmosphere.

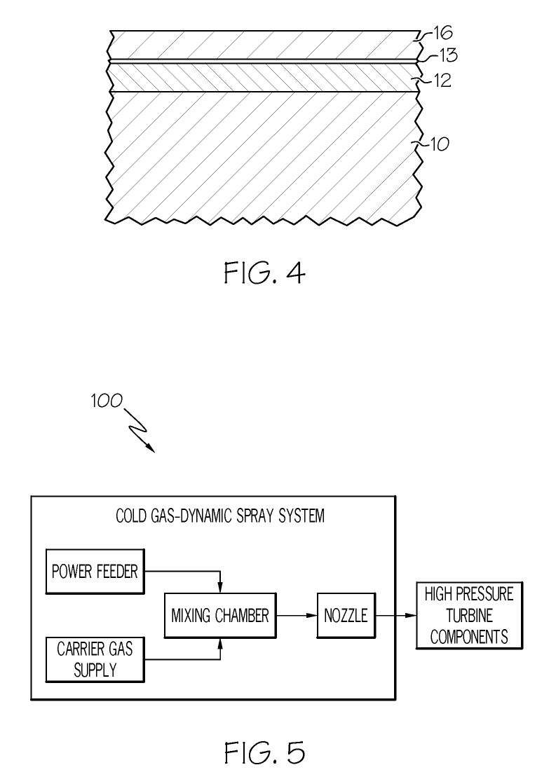

As a final step, a thermal barrier coating 16 is formed over the compacted bond coat 12 and the TGO 13. FIG. 4 is a cross-sectional view of the turbine engine component substrate depicted in FIG. 3 after forming a thermal barrier coating 16. The thermal barrier coating may be any conventional coating. An exemplary thermal barrier coating 16 is a ceramic material such as yttrium-stabilized zirconia.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for forming a bond coat on a turbine engine component, comprising the steps of:
cold spraying metal powder onto the turbine engine component to form a bond coat; and
shot peening the bond coat with particles at a sufficient velocity to compact and smooth the bond coat.

2. The method according to claim 1, wherein the step of shot peening the bond coat comprises accelerating spherical particles onto the bond coat.

3. The method according to claim 2, wherein the step of shot peening the bond coat comprises accelerating at least one type of spherical particles selected from the group consisting of glass spheres and metal spheres.

4. The method according to claim 3, wherein the step of shot peening the bond coat comprises accelerating glass spheres onto the bond coat.

5. The method according to claim 3, wherein the step of shot peening the bond coat comprises accelerating stainless steel spheres onto the bond coat.

6. The method according to claim 1, further comprising the step of:
forming a thermally-grown oxide on the bond coat by exposing the bond coat to controlled high temperatures after performing the shot peening step.

7. The method according to claim 6, further comprising the step of:
forming a thermal barrier coating on the thermally-grown oxide.

8. The method according to claim 7, wherein the thermal barrier coating comprises yttrium-stabilized zirconia.

9. The method according to claim 1, further comprising the step of:
performing a heat treatment after shot peening the bond coat at a temperature sufficient to improve bonding between the substrate and the bond coat.

10. The method according to claim 9, wherein the step of performing the heat treatment comprises heating the substrate and the bond coat in an inert atmosphere.

11. The method according to claim 9, wherein the step of performing the heat treatment comprises heating the substrate and the bond coat at a temperature ranging between 900° C. to 1100° C. for a predetermined time period ranging between 1 to 20 hours.

12. The method according to claim 9, wherein the step of performing the heat treatment comprises heating the substrate and the bond coat in an inert gas atmosphere with an oxygen partial pressure sufficient enough to form an alumina thermally-grown oxide layer.

13. A method for forming a bond coat on a turbine engine component, comprising the steps of:
cold spraying metal powder onto the turbine engine component to form a bond coat; and
cold spraying the bond coat with particles at a velocity that is sufficient for the particles to compact and smooth the bond coat, and that is insufficient for the particles to bond with the bond coat.

14. The method according to claim 13, wherein the step of cold spraying the bond coat with particles comprises compacting and smoothing the bond coat by spraying the metal powder that formed the bond coat.

15. The method according to claim 13, further comprising the step of:
forming a thermally-grown oxide on the bond coat by exposing the bond coat to controlled high temperatures after performing the step of cold spraying the bond coat with particles.

16. The method according to claim 15, further comprising the step of:
forming a thermal barrier coating on the thermally-grown oxide.

17. The method according to claim 16, wherein the thermal barrier coating comprises yttrium-stabilized zirconia.

18. The method according to claim 13, further comprising the step of:
performing a heat treatment after cold spraying the bond coat with particles at a velocity that is sufficient for the particles to compact and smooth the bond coat.

19. The method according to claim 18, wherein the step of performing the heat treatment comprises heating the substrate and the bond coat in an inert atmosphere.

20. The method according to claim 18, wherein the step of performing the heat treatment comprises heating the substrate and the bond coat at a temperature ranging between 900° C. and 1100° C. for a predetermined time period ranging between 1 and 20 hours.

21. The method according to claim 18, wherein the step of performing the heat treatment comprises heating the substrate and the bond coat in an inert gas atmosphere with an oxygen partial pressure sufficient enough to form an alumina thermally-grown oxide layer.
